(19) United States
(12) Patent Application Publication
(10) Pub. No.: US 2018/0075091 A1
(43) Pub. Date: Mar. 15, 2018

(54) GENERATING ATTRIBUTE-BASED GRANULAR DATABASE QUERY

(71) Applicants: Michael Weiss, Thousand Oaks, CA (US); Kurt Heim, Los Angeles, CA (US); Lawrence S. Rosner, Park Ridge, NJ (US)

(72) Inventors: Michael Weiss, Thousand Oaks, CA (US); Kurt Heim, Los Angeles, CA (US); Lawrence S. Rosner, Park Ridge, NJ (US)

(21) Appl. No.: 15/262,052

(22) Filed: Sep. 12, 2016

(51) Int. Cl. G06F 17/30

(52) U.S. Cl. CPC G06F 17/30392; G06F 3/04845; G06F 17/30554; G06F 17/30864

(57) ABSTRACT

A method for constructing an interactive database query interface. The method includes receiving a data structure including a search category for a consumable substance, an array of attributes associated with the search category, and range of values of the attributes. Each of the attributes indicates a physiological effect caused by ingesting the consumable substance. The range of values indicates intensity levels of the physiological effect. The method further includes dividing a graphical user interface in a plurality of sub-regions, and assigning a graphical representation in the graphical user interface with the search category and each of the plurality of sub-regions in the graphical user interface with one of the attributes in the array. The method further includes providing the graphical representation in the graphical user interface, where each of the plurality of attributes is displayed within the assigned sub-region of the graphical user interface.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

The present invention is in the field of database systems and, in particular, to systems, methods, and computer readable media for constructing a multi-dimensional query for a web search engine or database system.

### Description of the Related Art

Users commonly search websites and databases through keywords. Although such approaches may be effective at times, the users encounter difficulties in searching for particular items, products, equipment, or other types of information if the users do not know the appropriate keywords, or the existing keywords to not generate the desired search results. The difficulties in searching for correct information frequently extend to increased bandwidth use by client devices for which internet service providers regularly limit the extent of such bandwidth use, increased inbound network traffic on the server due to repeated server requests from several client endpoints which may cause queuing delay or other types of network delay that slow the packet transmission rates, and decreased productivity and efficiency for those who are seeking for the appropriate results generated by the web or database queries.

As an example, a user may want to find a product in an e-commerce website for an obscure replacement part of a mechanical equipment. The user is not a subject matter of the equipment domain, but perceives the general characteristics of the replacement part. Without knowing the appropriate name of the replacement part, however, the user is unable to retrieve the desired information about the replacement part because web search engine and the database system were unable to associate the characteristics and the mechanical equipment with said replacement part.

Further, users may desire to retrieve information based on several characteristics that may be associated therewith. It is sometimes possible to retrieve the desired information from a web search engine and database system using its characteristics (e.g., SQL command: “SELECT Products FROM Wine WHERE Color=‘RED’;”). These queries, however, are difficult to construct for users who are unfamiliar with the database schemas, let alone for those who are not trained with the programming languages associated with the database systems. Web search queries based on characteristics of the desired information can be difficult as well, since all preset filters are already predetermined by the search engine and plain text searches do not take into account that users are actually searching for information embodied with such characteristics and not the characteristics themselves.

Even when characteristics of the searched information is available, it is difficult in search providers to specify the extent of said characteristics present in the searched information. That is, although characteristics can be further searched within the retrieved information via filter keywords, the current web search and database queries are incapable of searching the intensity, degree of presence, and granularity of these characteristics based on filter keywords which primarily focus on whether said filter keywords are present within the retrieved information. As a consequence, the user is required to parse each result entry in the retrieved information to identify the appropriate information having the “right” amount of such characteristics.

For example, a user may want to find a cheese product that may include certain characteristics in sight, flavor, and smell. Although keyword filtering of cheese based on its flavors such as “earthy” or “floral” or smell that is “not pungent” may be possible, the user is unable to specify further on how intense the flavors or the smell should be for the cheese product towards which the search is performed. In another example, a user may want to find a restaurant that includes certain ambiance and noise level. Again, keyword filtering may describe a particular restaurant such as “loud” or “quiet,” but the user has no ability to create a database query that searches for a certain noise level desired for the restaurant. Thus, the current database systems and web search engines do not take into account for these granular queries, and thus the user has no options but to parse hundreds of search results in order to eventually find a cheese product that includes the appropriate intensity of the flavor.

There is thus a need to provide a query interface that allows users to search web sites and databases for items based on not only the attributes associated with said items, but also the amount of the attributes present in the items for which the users are searching.

### SUMMARY OF THE INVENTION

The present invention provides a method, system, and a computer program product for constructing an interactive database query interface. The method includes receiving a data structure including a search category for a consumable substance, an array of attributes associated with the search category, and range of values of the attributes. Each of the attributes indicates a physiological effect caused by ingesting the consumable substance. The range of values indicates intensity levels of the physiological effect caused by ingesting the consumable substance. The method further includes dividing a graphical user interface in a plurality of sub-regions, and assigning a graphical representation in the graphical user interface with the search category and each of the plurality of sub-regions in the graphical user interface with one of the attributes in the array. The graphical representation can be moved within the graphical user interface through user interaction. The method further includes providing the graphical representation in the graphical user interface, where each of the plurality of attributes is displayed within the assigned sub-region of the graphical user interface in response to the user engaging with the graphical representation.

According to another embodiment, the method comprises providing a content provider database comprising a taxonomy of consumable substances. Each consumable substance within the taxonomy is further associated with a plurality of search categories, an array of attributes corresponding to each of the plurality of search categories, and a value assigned to each of the array of attributes. Each of the attributes indicates a physiological effect caused by ingesting the consumable substance and the assigned value indicates intensity levels of the physiological effect caused by ingesting the consumable substance. The method further includes receiving a database query for the content provider database. The database query includes a series of query tokens indicative of at least one attribute for one of the plurality of search categories and the intensity level associated with the at least one attribute. The method further includes generating a query result that includes data corresponding to the consumable substance. The physiological effect and its intensity level associated with the consumable substance in the query result match the series of query tokens.

In some embodiments, the method may further comprise determining location coordinates of the graphical representation in the graphical user interface. The location coordinates include a first dimension value indicative of the attribute assigned within one of the plurality of sub-regions in the graphical user interface and a second dimension value indicative of a value within the range of values of the intensity level. The method further includes constructing a database query for the search category based on the location coordinates of the graphical representation.

In some embodiments, the method may further comprise receiving a query result that includes data corresponding to the consumable substance in response to providing the database query through a communication network. The physiological effect and its intensity level associated with the consumable substance in the query result match the first dimension value and the second dimension value respectively.

The system for constructing an interactive database query interface includes a content provider database configured to store data structures comprising a taxonomy of consumable substances, each consumable substance within the taxonomy further associated with a plurality of search categories and attributes corresponding to each of the plurality of search categories. The system further includes a processor, and a memory having executable instructions stored thereon that when executed by the processor cause the processor to receive one of the data structures including a first search category for the consumable substance, an array of attributes associated with the first search category, and range of values of the attributes, wherein each of the attributes indicates a physiological effect caused by ingesting the consumable substance and the range of values indicates intensity levels of the physiological effect caused by ingesting the consumable substance, divide a graphical user interface in a plurality of sub-regions, assign a graphical representation in the graphical user interface with the first search category and further assign each of the plurality of sub-regions in the graphical user interface with one of the attributes in the array, wherein the graphical representation can be moved within the graphical user interface through user interaction; and provide the graphical representation in the graphical user interface, wherein the each of the plurality of attributes is displayed within the assigned sub-region of the graphical user interface in response to the user engaging with the graphical representation.

### BRIEF DESCRIPTION OF THE SEVERAL VIEWS OF THE DRAWINGS

The invention is illustrated in the figures of the accompanying drawings which are meant to be exemplary and not limiting, in which like references are intended to refer to like or corresponding parts, and in which:

FIG. 1 presents a block diagram of a search system for generating a database query according to an embodiment of the present invention.

FIG. 2 presents a computing system of a search system for generating a database query and receiving query results according to an embodiment of the present invention.

FIG. 3A presents a block diagram of an example of a touch gesture based interface which enables configuration of parameters of a database query according to an embodiment of the present invention.

FIG. 3B presents a block diagram of another example of a touch gesture based interface which enables configuration of parameters of a database query according to an embodiment of the present invention.

FIG. 4 presents a block diagram of an example search result generated from the database query according to an embodiment of the present invention.

FIG. 5 presents a flowchart of a method for constructing a touch gesture based interface which enables configuration of parameters of a database query according to an embodiment of the present invention.

FIG. 6 presents a flowchart of a method for constructing a database query via the use of touch gesture based interface according to an embodiment of the present invention.

FIG. 7 presents a block diagram of an example database table of the computing system according to an embodiment of the present invention.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

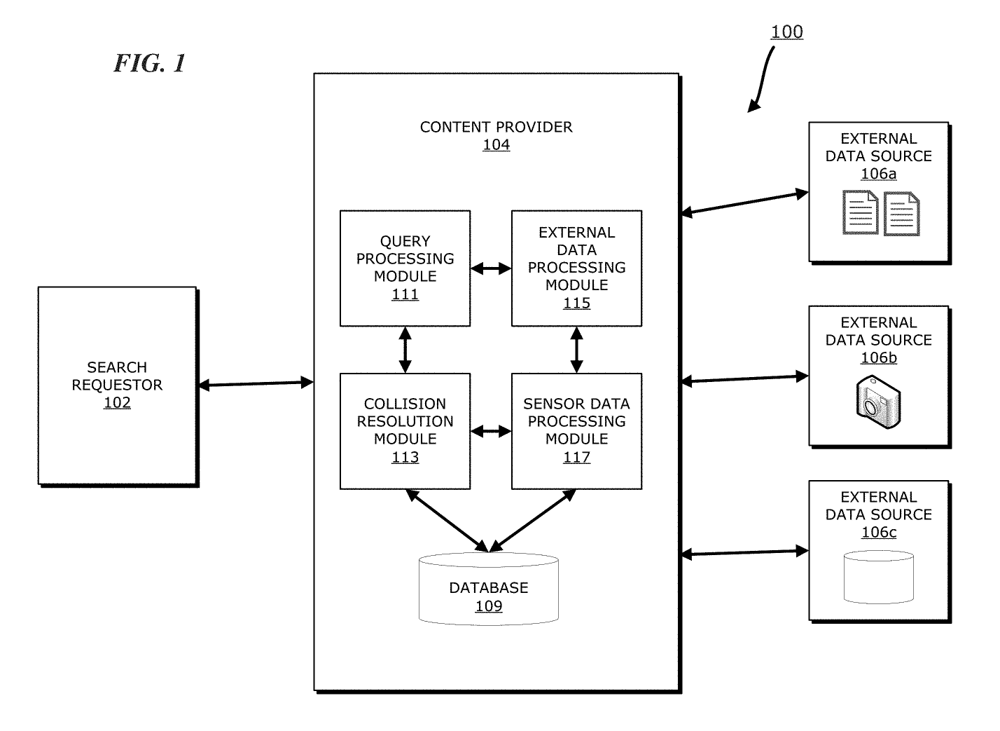

FIG. 1 presents a block diagram of a search system for generating a database query according to an embodiment of the present invention. System 100 includes search requestor 102, content provider 104, and external data sources 106a-106c. External data sources 106a-106c may include host servers, pub/sub message servers (e.g., external data source 106a), web crawlers, sensors (e.g., external data source 106b), wearable sensors, dictionary database servers (e.g., external data source 106c), and databases that provide data or content which may not be internally available in the search engine. Content provided by the external data sources 106a-106c may include electronic works such as books, articles, magazines, periodicals, regulatory documents, scientific publications, reports and digital, multimedia content. Content may further include those captured from sensors such as voice data, surveillance footage data, chemical compositions, biometric data, and data indicative of physiological status or changes. The content from external data sources 106a-106c may be digitally transmitted to, stored, and indexed at content provider 104.

Content provider 104 includes database 109, query processing module 111, collision resolution module 113, external data processing module 115, and sensor data processing module 117. Content maintained at content provider 104 may be stored in database 109. The content stored in database 109 may include, but are not limited to, video, audio, images, text, Portable Document Format (PDF) files, voice data, surveillance footage data, chemical compositions, biometric data, and data indicative of physiological status or changes, and any other types of file format supported by database 109 of content provider 104. According to one embodiment of the present invention, content provider 104 may provide a web application or service that responds to any types of queries that are created and digitally transmitted by search requestor 102.

Query processing module 111 may receive the database query and retrieve data stored and indexed within database 109 based on the database query. In some embodiments, query processing module 111 may parse and convert database queries that are not formatted with the same programming language or syntax as those required by content provider 104. A user may generate the database queries in any format that can be created by search requestor 102. In some embodiments, the format metadata may be transmitted along the database query to content provider 104. Content directed to sensor data such as voice data, surveillance footage data, chemical compositions, biometric data, and data indicative of physiological status or changes that are provided by external data sources 106a-106c may be categorized and staged by sensor data processing module 117. In some embodiments, external data processing module 115 and sensor data processing module 117 may operate as a single module interfacing between external data sources 106a-106c and database 109.

Search requestor 102 may generate a query and transmit the generated query to content provider 104 for query results. The query may be generated in order to receive information related to the query, retrieve a certain set of files and images, edit or create data within in content provider 104, or upload a set of files to content provider 104. A query may be coupled with contextual data associated with a user, time, or location to perform a more granular search.

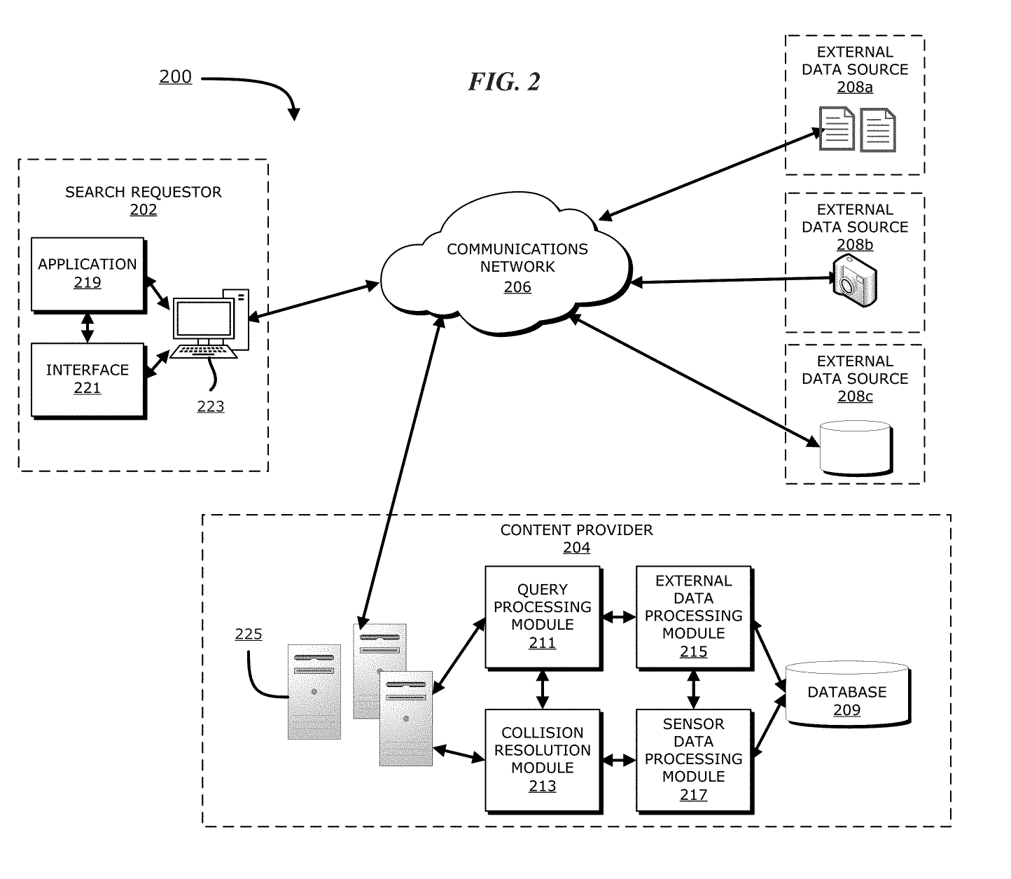

FIG. 2 presents a computing system for generating a database query and receiving query results according to an embodiment of the present invention. System 200 includes search requestor 202, content provider 204, communications network 206, and external data sources 208a-208c. Content provider 204 may include servers 225 that establish a network communication protocol with search requestor 202 through which network packets are exchanged, such as TCP/IP protocol or UDP protocol depending on type or size of data, or connection integrity required by search requestor 202. In one embodiment, servers 225 may include one or more file servers, web servers, FTP servers, application servers, etc.

Content provider 204 includes query processing module 211. Query processing module 211 may receive the database query and access database 209. After access is granted based on authorization credentials of search requester, query processing module 211 retrieves files, records, or any types of data stored in database 209. Query processing module 211 translates the database query that conforms to syntax rules as required by the programming language (e.g., SQL) under which content provider 204 operates. Query processing module 211 receives the inbound query and parses the query tokens to identify the type of the incoming query. Once the type of the incoming query is identified, a set of rules or application programming interfaces stored in a query dictionary will be invoked to parse and convert the inbound query to match the syntax that can be processed by content provider 204. In some embodiments, redundant information such as content within title or head tags in may be removed when query processing module 211 converts an inbound query in XML format to SQL format. An inbound query may include program commands received from search requestor 202 such as program-specific query, a Structured Query Language (SQL) query, Extensible Markup Language (XML) file, natural language keyword tokens, and media files. Content such as video, audio, images, text, and Portable Document Format (PDF) files provided by external data sources 208a-208c may be categorized and staged by external data processing module.

Content provider 204 includes database 209, which receives the database query from query processing module 211 and provides responses to the database query as previously described. Database 209 may be a relational database that includes data structures having tabular expressions (e.g., rows and columns), a primary key for each row and/or column, and any foreign keys which allow the data structures to operate dependent from each other to generate a query result. In an example embodiment, database 209 may include a plurality of row entries pertaining to a subject domain such as cannabis. For each entry, database 209 may include a strain identifier (designated as PRIMARY_KEY, UNIQUE), strain name, strain type, a set of string arrays indicative of sensory effects of the strain such as bitter taste, another set of string arrays indicative of medical effects of the strain, numerical expressions assigned to each array index for both sets which represent a degree of presence or intensity levels of such sensory effects or medical effects, numerical variable indicative of a review rating, and/or so forth.

In some embodiments, query processing module 211 may reconfigure inbound database queries and query results, so as to be consistent with the data stored in database 209. For example, interface 221 provides a search query for a type of wine that has a “low” herbal taste with “medium” dryness, both of which are expressed as string values. As this search query is received, content provider 204 determines that the database schema of database 209 includes only floating integer values for a set of columns indicating the intensity of a particular taste in wine, and, in response, query processing module 211 of content provider 204 recasts the string query values of “low” herbal and “medium” dryness to “21%” herbal and “56%” dryness. The granularity of how “low” a particular attribute to be configured into a certain floating integer value is enabled by the location of the graphical representations that the user can designate via interface 221, the details further described in the embodiments set forth below. Once the query results are generated by database 209, query processing module 211 may recast the integer value query results back to the string values consistent with the parameters being displayed on interface 221. In this manner, query processing module 211 may reconfigure certain portions of the search query to execute a proper search, consistent with the syntax required by database 209.

Content provider 204 may automatically populate content provided by external data sources 208a-208c. External data sources 208a-208c may be any type of device, sensor, or file repository capable of pushing different types of data through communications network 206. For example, one of external data sources 208a-208c may be an electrochemical sensor that captures facial expression response of a user drinking a sour wine, converts the facial expression response into computer readable data, and transmits the computer readable data to database 209 which will insert the data under the row that identifies the sour wine and column that identifies “taste.” In another example, one of external data sources 208a-208c may be a pub/sub server that periodically transmits documents that relate to a specific strain of cannabis, which is parsed in content provider 204 and automatically populated in database 209 under appropriate column fields assigned to the specific strain. Communications network 206 may be any suitable type of network allowing transport of data communications across thereof. In one embodiment, the network may be the Internet, following known Internet protocols for data communication, or any other communication network, e.g., any local area network (LAN), or wide area network (WAN) connection.

In some embodiments, content imported from external data sources 208a-208c may be raw data and cannot be immediately ingested by database 209. Content provider 204 assign transmitted raw data to external data processing module 215 or sensor data processing module 217 depending on the type of data being ingested. External data processing module 215 may include natural language processing (NLP) sub-module that parses unstructured data from documents, extracts tokens that qualify as different types of an attribute pertaining to a subject domain, and generates a database statement (e.g., INSERT INTO Food (column2, column4, column5) VALUES (token1, token2, token3);) that instructs content provider 204 to insert the extracted tokens into database 209. In another embodiment, external data processing module 215 may also include a video processing sub-module that captures an image frame from a streaming video file, extracts metadata attributes from the image frame that pertain to the subject domain, and generates a second database statement that instructs content provider 204 to replace the outdated metadata attributes already stored in database 209.

If content provider 204 determines that the ingested data transmitted by external data sources 208a-208c is sensor data, content provider 204 calls sensor data processing module 217 to translate the ingested sensor data and insert the translated data into database 209. For example, sensor data may include electric current information detected by electrodes that capture different senses such as taste from a consumable substance such as wine. As the electric current information is received by content provider 204, sensor data processing module 217 identify a category (e.g., taste) associated with the electrodes, classifies the electric current information as an attribute under the category (e.g., sweet), and determines a numerical value that represents the intensity of the taste based on the electric current information. Once the processing of sensor data is complete, sensor data processing module 217 may generate a database statement to enter the processed information to database 209.

Content provider 204 includes collision resolution module 213, which normalizes values captured by an external data source that may conflict with values already stored in database 209 or that may collide with another set of values that were captured by another external data source. For instance, documents processed through external data processing module 215 may identify a strain as causing increased alertness, whereas biochemical composition captured by sensor data processing module 217 indicates a significant spike of melatonin, which is a hormone widely associated with relaxation and sleepiness. When such data integrity presents a collision, collision resolution module 213 may perform a trace command to track how each value was identified then classified and adjust portions of algorithm within either external data processing module 215 or sensor data processing module 217 to resolve such collision. In this example, a categorization of “sleepiness” for melatonin may have been inaccurate under certain context as the hormone sometimes does not induce sleep but rather increases sleep efficiency. In response, collision resolution module 213 inserts the value processed through external data processing module 215 and adjusts the classification algorithm within sensor data processing module 217.

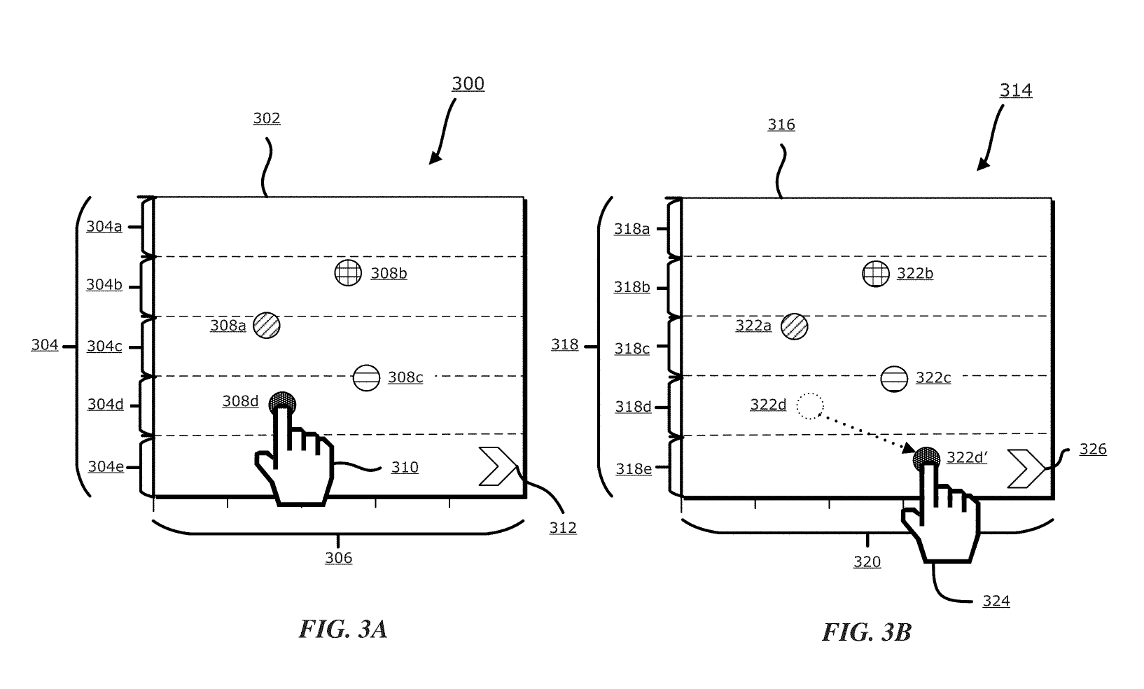

Search requestor 202 includes application 219 and interface 221, which interact together to generate a series of query tokens based on the location coordinates of the graphical representations (e.g., icons 308A-308D in FIG. 3A) displayed within the boundaries of the interface 221. In several embodiments, Search requestor 202 may be client 223. Client 223 may include desktop personal computers, workstations, terminals, laptops, personal digital assistants (PDAs), cell phones, an iPod®, a smart phone, such as a Blackberry® or iPhone®, tablet personal computers such as iPad®, or any computing device capable of connecting to communications network 206, including a wireless communication network.

Interface 221 includes graphical representations displayed thereon, which are enabled to be manipulated therein via peripheral devices or touch based gestures to specify location coordinates within interface 221. Each graphic representation is mapped to a set of attributes that are directed to a common category in the search domain and a range of values specifying the amount of each specified characteristic that requires to be present in query results. In another embodiment, interface 221 may include several graphical representations that are concurrently displayed, wherein each graphical representation indicates a category associated with the search domain, so as to allow content provider 204 to iteratively filter query results based on the characteristics and the corresponding extent of said characteristics based on all categories with which the graphical representations are associated. Interface 221 may be a graphical user interface (GUI) or a browser application provided on a display (e.g., monitor screen, LCD or LED display, projector, etc.). Interface 221 may also include a touch interface, such as touch screen displays, smartphones with touch screen, and portable devices with touch screens.

Application 219 receives input, e.g., location coordinates of graphical representations, from interface 221 and constructs database query based on the received input. That is, for each graphical representation present within a region of the interface 221, application 219 constructs a query token by incorporating a data structure (e.g., array, map, linked list) assigned with a first value associated with the x-axis coordinate and a second value associated with the y-axis coordinate. In other words, application 219 receives location coordinates of graphical representations displayed within the boundaries of interface 221 and configures the context of the database query by allowing a user to identify the percentages of each characteristic that should be present in the query results. In several embodiments, a user may use interface 221 and application 219 to “dial-in” combinations of desired effects and fine-tune exactly how much of each characteristic the user desires, such as dryness in wine, pain reducing effects of cannabis, or certain physiological effects in other consumable goods and substances (e.g., medicine, coffee, wine, cheese, herbs, tea).

In one embodiment, application 219 may refine or adjust the database query by associating it with contextual data relevant to the user. For example, sensors coupled to a wearable device may detect the emotional state, physiological state, or genetic information of the user, encrypt the detected information, and adjust the query based on the encrypted data. In some embodiments, application 219 may transmit the database query and the encrypted data to allow content provider 204 to use the encrypted data to adjust entries stored in database 209, or yet additionally filter the query results returned from the initial database query with the encrypted data. Contextual data may include voice input, text input, biometric data, and accelerometer and haptic data.

FIG. 3A presents a block diagram of an example of a touch gesture based interface which enables configuration of parameters of a database query according to an embodiment of the present invention. Application 300 may be application 219 in FIG. 2. Application 300 includes an interface, such as interface 221 of search requestor 202 in FIG. 2.

In this example embodiment, application 300 displays an interface 302 from which query parameters within the context of a subject domain can be generated. Interface 302 can be divided into regions depicted by attribute axis 304 and value axis 306. Attribute axis 304 is divided into regions 304a-304e, each of which are assigned with an attribute or characteristic for a search category associated with one of icons 308a-308d. In some embodiments, attributes assigned to icons 308a-308d specifically indicate a sensed perception or physiological response caused by ingesting a substance for which the search is performed. For instance, application 300 is a search application for a specific strain of cannabis, which correlates icon 308a to an emotion category. Once icon 308a is triggered, application 300 assigns each of regions 304a-304e in attribute axis 304 with different types of emotion attributes, such as ecstatic attribute in 304a, happy attribute in 304b, creative attribute in 304c, alert attribute in 304d, and ecstatic attribute in 304e. Regions 304a-304e respectively assigned with attributes are then both displayed on interface 302. In addition, application 300 may include value axis 306 that presents a range of values which can specify the presence or intensity for the attributes assigned to regions 304a-304e. Continuing with the above example, value axis 306 may be a range of values between 0-100 from left to right order, in which icon 308a is located on region 304c which is associated with creative attribute. The placement of icon 308a indicates a lower creative attribute value relative to the attribute value associated with icon 308b (under different search category) since icon 308b is located to the right of icon 308a thus indicating a higher intensity or a stronger presence of the attribute depicted in region 304b.

While each axis (e.g., attribute axis 304) in interface 302 in this figure is designated with an attribute and a value respectively, such designations are not intended to be limiting on the illustrative embodiments. In some embodiments, attribute axis 304 representative of y-axis and value axis 308b representative of x-axis in interface 302 can be switched. In additional embodiments, application 300 can designate axis 304, regions 304a-304e, and/or 306 with different types of values which correlate to search categories represented by any of icons 308a-308d and stored in database 209 in FIG. 2. Those of ordinary skill in the art will be able to adapt other embodiments to use similar designations of values instead of attributes within a category of the subject domain, and such adaptations are contemplated within the scope of the illustrative embodiments.

Icons 308a-308d each represents a graphical representation that can be moved within the boundaries of interface 302, and its relative position within regions 304a-304e of interface 302 identifies the attribute association with one of regions 304a-304e and the corresponding degree of presence in said attribute as specified by value axis 306. In some embodiments, each of the icons 308a-308d may represent one of the plurality of search categories under the subject domain assigned by application 300.

In another embodiment, each of icons 308a-308d may include different types of ranges assigned to value axis 306. For instance, icon 308a may correspond to emotion states search category and numerical range of values from 0 to 100. Icon 308b may correspond to physical effects search category but different numerical range of values from 0 to 5. Icon 308c may correspond to medical effects search category which includes and character values depicting a range from none, weak, medium, strong, and maximum. Icon 308d may correspond to taste senses search category which includes range of colors from light to dark, which characterizes intensity of the attribute as the axis moves towards the darker region.

In an example embodiment of FIG. 3, a search application for cannabis strains 300 is presented, which includes at least four icons 308a-308d, each icon corresponding to a search category commonly associated with cannabis. In this example, each of icons 308a-308d include a plurality of attributes associated with the search category:

Emotion effect category under icon 308a—emotional states including observable mental states, transient psychological states that may change over time, perceived changes between the emotional states as compared with a previous or alternative bit-addressable representation of the emotional state, or relationships between states. The attributes associated with icon 308a are assigned to regions 304a-304e, which are shown on interface 302 once a user touches or clicks icon 308a. Example attributes assigned to regions 304a-304e include ecstatic 304a, happy 304b, creative 304c, alert 304d, and calm 304e;

Physical effect category under icon 308b—physical effects including observable physical state, transient physiological states that may change over a period of time, perceived changes between the physical states as compared with a previous or alternative bit-addressable representation of the physical state, or relationships between states. The attributes associated with icon 308b are assigned to regions 304a-304e, which are shown on interface 302 once a user touches or clicks icon 308b. Example attributes assigned to regions 304a-304e include energetic 304a, rejuvenated 304b, focused 304c, relaxed 304d, and sleepy 304e;

Medical effect category under icon 308c—medical effects including descriptions of medical effect, descriptions based on observable cause and effect of a chemical composition in the substance, symptom and diagnosis, and medical conditions. The attributes associated with icon 308c are assigned to regions 304a-304e, which are shown on interface 302 once a user touches or clicks icon 308c. Example attributes assigned to regions 304a-304e include combat fatigue 304a, relieve headaches 304b, relieve stress 304c, reduce anxiety 304d, and ease pain 304e; and

Taste category under icon 308d—taste including descriptions of taste commonly associated with the substance, description representative of gustatory system reactions, and perceived changes in the taste cells. The attributes associated with icon 308d are assigned to regions 304a-304e, which are shown on interface 302 once a user touches or clicks icon 308d. Example attributes assigned to regions 304a-304e include sweet 304a, citrus 304b, flowery 304c, spicy 304d, and bitter 304e.

In another example embodiment of FIG. 3, a search application for a restaurant 300 is presented, which includes at least four icons 308a-308d, each icon corresponding to a search category commonly associated with cuisines or other criteria pertinent to the restaurant industry. In this example, each of icons 308a-308d include a plurality of attributes associated with the search category:

Ambiance category under icon 308a—ambiance of a restaurant which includes certain lighting, atmosphere, and conditions that aim to attract a certain group of customers. The attributes associated with icon 308a are assigned to regions 304a-304e, which are shown on interface 302 once a user touches or clicks icon 308a. Example attributes assigned to regions 304a-304e include casual 304a, romantic 304b, noise 304c, lighting 304d, and interior design 304e;

Cuisine category under icon 308b—cuisine including dishes having different degrees of traditional, modern, or fusion type offered by the restaurants. The attributes associated with icon 308b are assigned to regions 304a-304e, which are shown on interface 302 once a user touches or clicks icon 308b. Example attributes assigned to regions 304a-304e include American cuisine 304a, French cuisine 304b, Italian cuisine 304c, Chinese cuisine 304d, and Latin American cuisine 304e;

Price category under icon 308c—price for different types of dishes, drinks, or desserts offered by restaurants. In some circumstances, certain patrons of the restaurant may search for affordable drinks yet will not mind if the main courses are expensive. The attributes associated with icon 308c are assigned to regions 304a-304e, which are shown on interface 302 once a user touches or clicks icon 308c. Example attributes assigned to regions 304a-304e include lunch 304a, dinner 304b, brunch 304c, drinks 304d, and appetizers/desserts 304e; and

Taste category under icon 308d—taste including descriptions of taste commonly associated with the dishes offered by restaurants, description representative of gustatory system reactions, and perceived changes in the taste cells. The attributes associated with icon 308d are assigned to regions 304a-304e, which are shown on interface 302 once a user touches or clicks icon 308d. Example attributes assigned to regions 304a-304e include sweet 304a, spicy 304b, savory 304c, umami 304d, and unique 304e.

As described above, the location coordinates or other indicia of relative positions of icons 308a-308d within interface 302 determine a set of query tokens to be generated. As an example, the y-axis coordinates corresponding to icons 308a-308d will identify the attribute specified by the one of regions 304a-304e, whereas the x-axis location coordinate positions corresponding to icons 308a-308e identify the value specified by value axis 306.

In other embodiments, the association between icons 308a-308d may vary depending on search domain or the software application to which an embodiment is directed. In some embodiments, the aforementioned association may further vary based on the specified input or output mechanism, and/or bit-addressable values. In some embodiments, the association between icons 308a-308d may be parameterized between the input and/or output processes. In another embodiment, the timing or sequence of relevance among the icons 308a-308d in interface 302 may adjust or transform database query and/or may create additional associations with other data elements (e.g., location, meta-data, time, price, reputation, recognition, privacy considerations) external to application 300 configuring or otherwise constructing the database query, yet relevant to the attributes associated with the search categories assigned to icons 308a-308d.

While the graphical representations (e.g., icons 308a-308d) in this figure include four graphical representations depicted as circular, such number and shapes of such graphical representations are not intended to be limiting on the illustrative embodiments. For example, icons or other types of graphical representations can be identified as squares, rectangles, triangles, or any other suitable shape, as described with respect to some embodiments. Furthermore, graphical representations present in the interface may be more than ten. Those of ordinary skill in the art will be able to adapt other embodiments to use different numbers and/or similar shapes instead of four circular graphical representations, and such adaptations are contemplated within the scope of the illustrative embodiments.

In one embodiment, pointer 310 is a user's hand which places its pointer finger on the region displaying icon 308d within interface 302. As pointer 310 initiates contact with icon 308d, interface 302 will respond in real-time by displaying the list of attributes assigned to regions 304a-304e in attribute axis 304 and the list of values in value axis 306, where the list of attributes and the list of values are associated with a search category to which icon 308d corresponds. Using a touch based gesture, pointer 310 may relocate the position of icon 308d elsewhere as long as the icon 308d is placed within the boundaries of interface 302. In several embodiments, pointer 310 can be another pointing device such as a mouse, a smart pen, or other peripheral devices that can be contemplated as a pointing device by those of ordinary skill in the art.

Finally, search button 312 depicts a graphical representation, that, when clicked or otherwise activated, application 300 generates a series of query tokens based on the location coordinates of icons 308a-308d displayed in interface 302. Application 300 generates the database queries by utilizing embedded data structures, script engine, and query construction algorithm that allows users to perform fast and granular searches that return an accurate search result, otherwise not found through conventional means of web search or database system queries.

FIG. 3B presents a block diagram of another example of a touch gesture based interface which enables configuration of parameters of a database query according to an embodiment of the present invention. Application 314 is similar to application 300 in FIG. 3A. Interface 316 is an interface, analogous to interface 302 in FIG. 3A. Attribute axis 318 and value axis 320 are analogous to attribute axis 304 and value axis 306 respectively in FIG. 3A. Regions 318a-318e are analogous to regions 304a-304d respectively in FIG. 3A. Icons 322a-322d are analogous to icons 308a-308d respectively in FIG. 3A. Pointer 324 is analogous to pointer 310 in FIG. 3A. Search button 326 is analogous to search button 312 in FIG. 3A.

In this example embodiment, pointer 324 relocates icon 322d to a new location coordinate, which now represents icon 322d′. As described previously in FIG. 3A, the location coordinates of icon 322d′ within interface 316, which is relocated from the previous location indicated by 322d, result in application 314 generating a set of query tokens that are different the set of query tokens that would be generated from interface 302. Application 314 ultimately constructs a database query that searches for a different attribute from the database query generated by application 300. This is because icon 322d′ is now situated in region 318e, which is in a different area from 381d where icon 322d originally was. Thus, as search button 326 executes, application 314 generates a series of query tokens based on the location coordinates of icons 322a, 322b, 322c (all in same positions as icon 308a, 308b, and 308c respectively in FIG. 3A), and 322d′ (in a different position from icon 308d in FIG. 3A).

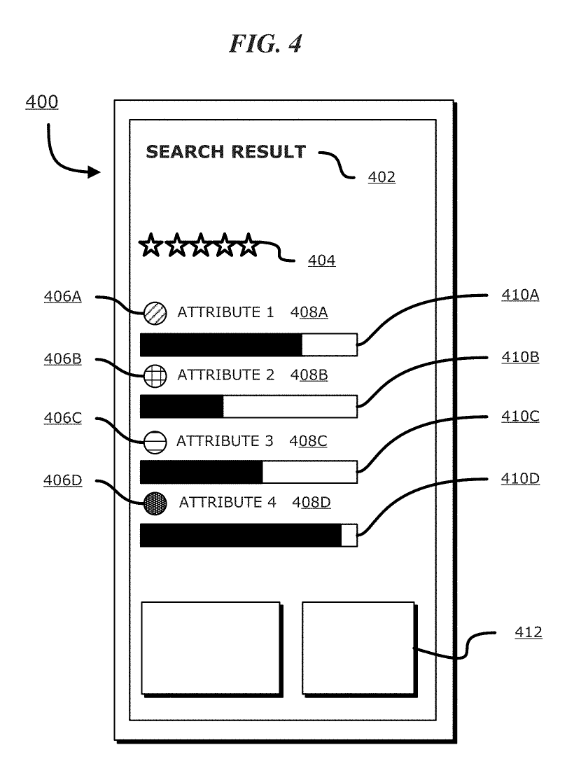

FIG. 4 presents a block diagram of an example search result generated from the database query according to an embodiment of the present invention. Interface 400 is a graphical user interface, such as interface 221 of search requestor 202 in FIG. 2.

Query result 402 depicts data returned by content provider 204 in response to the database query constructed from application 300 of FIG. 3A or application 314 from FIG. 3B. Rating 404 may depict an average rating based on aggregating reviews and/or ratings previously submitted by other users with regards to query result 402. In other embodiments, rating 404 may be indicative of a confidence level that query result 402 was the appropriate search result in view of all attributes and values that formed as a part of the database query.

Icons 406a-406d depict graphical representations in which the location coordinates of each graphical representation within interface 302 in FIG. 3A or interface layer 314 in FIG. 3B identify the corresponding attribute and value being searched. Attributes 408a-408d each depicts an attribute associated with icons 406a-406d respectively, which are identified based on the location of icons 406a-406d in regions 304a-304e in FIG. 3A or regions 318a-381e in FIG. 3B. Prevalence indicators 410a-410d each depicts a value associated with attributes 408a-408d, which are identified based on the relative positions of icons 406a-406d within value axis 306 in FIG. 3A or value axis 320 in FIG. 3B. In some embodiments, prevalence indicators 410a-410d may be values within a range of values that specify the degree of prevalence or intensity of attributes 408A-408d. Relevant result 412 depicts any other data that may be relevant to query result 402. In some embodiments, relevant result 412 may be determined by content provider 204 in FIG. 2 without regards to the database query generated from interface 221 according to an embodiment of the present invention. In other embodiments, content provider 204 may provide relevant result 412 may be depicted based on some overlap with the attributes and values included in the database query.

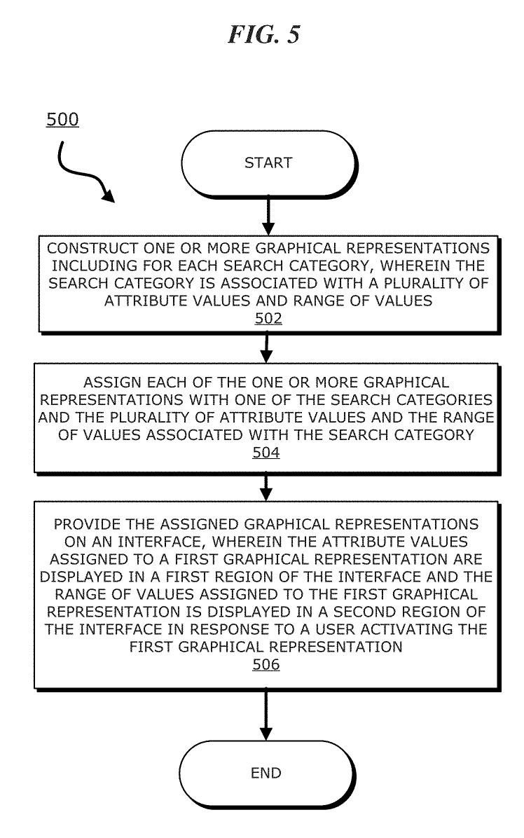

FIG. 5 presents a flowchart of a method for constructing a touch gesture based interface which enables configuration of parameters of a database query according to an embodiment of the present invention. Process 500 can be implemented in an application, such as application 219 in FIG. 2 or application 300 of FIG. 3A.

The application constructs one or more graphical representations, e.g., icons 308a-308d in FIG. 3A, for each search category within a subject domain, for each search category, wherein the search category is associated with a plurality of attribute values and range of values (block 502). The application assigns each of the one or more graphical representations with one of the search categories and the plurality of attribute values and the range of values associated with the search category (block 504). In one embodiment, the application assigns interactive graphical presentation with an initial set of location coordinates in the interface, such as interface 221 of FIG. 2.

The application provides the assigned graphical representations on an interface, wherein the attribute values assigned to a first graphical representation are displayed in a first region of the interface and the range of values assigned to the first graphical representation is displayed in a second region of the interface in response to a user activating the first graphical representation (block 506). In this embodiment, the application simultaneously displays one or more graphical representations within the boundaries of interface. In one embodiment, the application may assign associations between the graphical representations which may vary depending on search domain or the software application to which an embodiment is directed. In other embodiments, the aforementioned association may further vary based on the specified input or output mechanism, and/or bit-addressable values. In some embodiments, the association between the graphical representations may be parameterized between the input and/or output processes. In another embodiment, the timing or sequence of relevance among the graphical representations in the interface may adjust or transform the database query and/or may create additional associations with other data elements (e.g., location, meta-data, time, price, reputation, recognition, privacy considerations) external to the interface configuring or otherwise constructing the query, yet relevant to the attributes associated with the search categories assigned to the graphical representations.

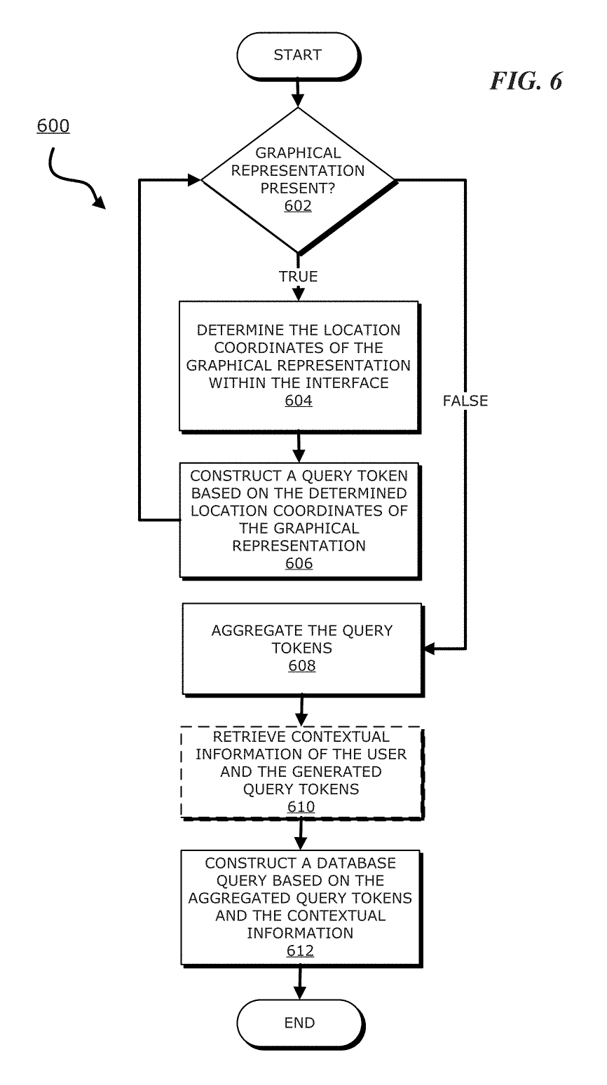

The application ends process 500 thereafter. For example, the application can display the graphical representations on interface 302 in FIG. 3A, or can be further utilized throughout the process as illustrated in process 600 in FIG. 6.

FIG. 6 presents a flowchart of an example process for constructing a database query via the use of touch gesture based interface according to an embodiment of the present invention. Process 600 can be implemented in an application, such as application 219 in FIG. 2 or application 300 of FIG. 3A.

The application identifies whether any graphical representations are present in the interface, e.g., interface 302 in FIG. 3A (block 602). For each graphical representation found, the application determines the location coordinates of the graphical representation within the interface (block 604) and constructs a query token based on the determined location coordinates of the graphical representation (block 606). In one embodiment, the application constructs a query token by determining an attribute based on a first dimension of the location coordinate of the graphical representation and a degree of prevalence or intensity of said attribute based on a second dimension of the location coordinate of the graphical representation. The application iterates through the steps depicted in blocks 602, 604, and 606, until the application processes all graphical representations.

The application aggregates the query tokens for the graphical representations (block 608). Optionally, the application can retrieve contextual information of the user and the generated query tokens (block 610). The application constructs a database query based on the aggregated query tokens and the contextual information (block 612). In another embodiment, the application may refine or adjust database query by based on the contextual information. The application ends process 600 thereafter.

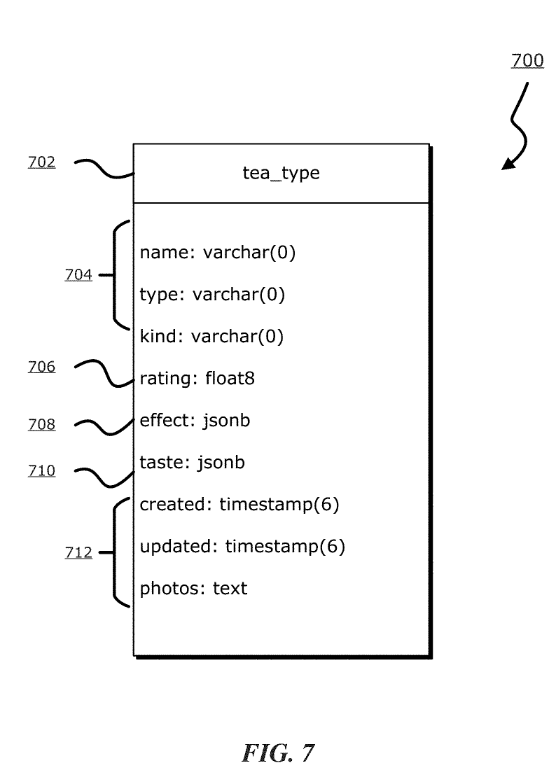

FIG. 7 presents a block diagram of an example database schema of the computing system according to an embodiment of the present invention. Schema 700 may be included in database 209 of FIG. 2. Schema 700 provides table definition 702 and column definitions 704, 706, 708, 710, and 712. In this example embodiment, table definition 702 provides a dataset for a specific member of the tea family, which includes name and type column definitions 704 for name (e.g., rooibos tea), type (e.g., red), and kind (e.g., non-caffeinated) columns. These are populated with varchar variables, and are typically displayed as text on a graphical user interface, such as interface 221 in FIG. 2. Rating column definition 706 includes a floating integer variable that indicates a rating of the particular tea, which may be expressed as a percentage (e.g., 85%) or an integer value rounded up to a single decimal (e.g., 4.5 stars). Effect column definition 708 may include a metadata set such as JSON or XML that identifies a varchar variable depicting an effect that may be caused by consuming the type of tea (e.g., reduces seasonal allergies) and an integer value associated with such varchar variable that indicates the amount of effect that is caused by consuming such tea. For example, the integer value in the JSON set within effect column definition 708 is 85, which may depict that rooibos tea has an 85% likelihood to reduce seasonal allergies. Taste column definition 710 provides may include another metadata set such as JSON or XML that identifies a varchar variable depicting taste commonly associated with the tea (e.g., earthy) and an integer value depicting the intensity of the identified taste (e.g., 90). Miscellaneous column definition 712 may provide other types of values that may be useful for other purposes within a server system, e.g., content provider 204, such as the time the table was created or updated, and any media files such as images or videos that are associated with the name and type column definitions 704.

While schema 700, table definition 702, and column definitions 704, 706, 708, 710, and 712 in this figure include certain variables types and columns, such database schemas are not intended to be limiting on the illustrative embodiments. For example, schema 700 may include additional columns such as medical effect and emotional effect depending on how the database is defined, as described with respect to some embodiments. In another example, name and type column definitions 704 may be directed to another search domain, such as cheese or wine. Those of ordinary skill in the art will be able to adapt other embodiments to use different table definitions, columns, variable types, and schemas, and such adaptations are contemplated within the scope of the illustrative embodiments.

FIGS. 1 through 7 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for constructing an interactive database query interface, the method comprising:
receiving, by a processor, a data structure including a search category for a consumable substance, an array of attributes associated with the search category, and range of values of the attributes, wherein each of the attributes indicates a physiological effect caused by ingesting the consumable substance and the range of values indicates intensity levels of the physiological effect caused by ingesting the consumable substance;
dividing, by the processor, a graphical user interface in a plurality of sub-regions;
assigning, by the processor, a graphical representation in the graphical user interface with the search category and further assigning each of the plurality of sub-regions in the graphical user interface with one of the attributes in the array, wherein the graphical representation can be moved within the graphical user interface through user interaction; and
providing, by the processor, the graphical representation in the graphical user interface, wherein the each of the plurality of attributes is displayed within the assigned sub-region of the graphical user interface in response to the user engaging with the graphical representation.

2. The method of claim 1, further comprising:
determining, by the processor, location coordinates of the graphical representation, the location coordinates including a first dimension value indicative of the attribute assigned within one of the plurality of sub-regions in the graphical user interface and a second dimension value indicative of a value within the range of values of the intensity level; and
constructing, by the processor, a database query for the search category based on the location coordinates of the graphical representation.

3. The method of claim 2, further comprising:
in response to providing the database query through a communication network, receiving, by the processor, a query result that includes data corresponding to the consumable substance, wherein the physiological effect and its intensity level associated with the consumable substance in the query result match the first dimension value and the second dimension value respectively.

4. The method of claim 1, wherein:
the search category is an emotion effect category caused by ingesting the consumable substance; and
the attribute associated with the search category is selected from a group of attributes consisting of: ecstatic, happy, creative, alert, and calm.

5. The method of claim 1, wherein:
the search category is a medical effect category caused by ingesting the consumable substance; and
the attribute associated with the search category is selected from a group of attributes consisting of: reduce fatigue, relieve headaches, relieve stress, reduce anxiety, and ease pain.

6. The method of claim 1, wherein:
the search category is a taste category associated with the consumable substance; and
the attribute associated with the search category is selected from a group of attributes consisting of: sweet, citrus, flowery, spicy, and bitter.

7. The method of claim 4, wherein the group of attributes associated with the search category includes biometric data captured by a wearable sensor of a user interacting with the graphical user interface.

8. A system for constructing an interactive database query interface, the system comprising:
a content provider database configured to store data structures comprising a taxonomy of consumable substances, each consumable substance within the taxonomy further associated with a plurality of search categories and attributes corresponding to each of the plurality of search categories;
a processor; and
a memory having executable instructions stored thereon that when executed by the processor cause the processor to:
receive one of the data structures including a first search category for the consumable substance, an array of attributes associated with the first search category, and range of values of the attributes, wherein each of the attributes indicates a physiological effect caused by ingesting the consumable substance and the range of values indicates intensity levels of the physiological effect caused by ingesting the consumable substance;
divide a graphical user interface in a plurality of sub-regions;
assign a graphical representation in the graphical user interface with the first search category and further assign each of the plurality of sub-regions in the graphical user interface with one of the attributes in the array, wherein the graphical representation can be moved within the graphical user interface through user interaction; and
provide the graphical representation in the graphical user interface, wherein the each of the plurality of attributes is displayed within the assigned sub-region of the graphical user interface in response to the user engaging with the graphical representation.

9. The system of claim 8, wherein the processor is configured to:
determine location coordinates of the graphical representation, the location coordinates including a first dimension value indicative of the attribute assigned within one of the plurality of sub-regions in the graphical user interface and a second dimension value indicative of a value within the range of values of the intensity level; and
construct a database query for the search category based on the location coordinates of the graphical representation.

10. The system of claim 9, wherein the processor is configured to:
in response to providing the database query through a communication network, receive a query result that includes data corresponding to the consumable substance, wherein the physiological effect and its intensity level associated with the consumable substance in the query result match the first dimension value and the second dimension value respectively.

11. The system of claim 8, wherein:
the first search category is an emotion effect category caused by ingesting the consumable substance; and
the attribute associated with the first search category is selected from a group of attributes consisting of: ecstatic, happy, creative, alert, and calm.

12. The system of claim 8, wherein:
the first search category is a medical effect category caused by ingesting the consumable substance; and
the attribute associated with the first search category is selected from a group of attributes consisting of: reduce fatigue, relieve headaches, relieve stress, reduce anxiety, and ease pain.

13. The system of claim 8, wherein:
the first search category is a taste category associated with the consumable substance; and
the attribute associated with the first search category is selected from a group of attributes consisting of: sweet, citrus, flowery, spicy, and bitter.

14. The system of claim 11, wherein the group of attributes associated with the search category includes biometric data captured by a wearable sensor of a user interacting with the graphical user interface.

15. A method for generating a database query result for a consumable substance, the method comprising:
providing, by a processor, a content provider database comprising a taxonomy of consumable substances, each consumable substance within the taxonomy further associated with a plurality of search categories, an array of attributes corresponding to each of the plurality of search categories, and a value assigned to each of the array of attributes, wherein the each of the attributes indicates a physiological effect caused by ingesting the consumable substance and the assigned value indicates intensity levels of the physiological effect caused by ingesting the consumable substance;
receiving, by the processor, a database query for the content provider database, the database query including a series of query tokens indicative of at least one attribute for one of the plurality of search categories and the intensity level associated with the at least one attribute; and
generating, by the processor, a query result that includes data corresponding to the consumable substance, wherein the physiological effect and its intensity level associated with the consumable substance in the query result match the series of query tokens.

16. The method of claim 15, wherein:
the search category is an emotion effect category caused by ingesting the consumable substance; and
the attribute associated with the search category is selected from a group of attributes consisting of: ecstatic, happy, creative, alert, and calm.

17. The method of claim 15, wherein:
the search category is a medical effect category caused by ingesting the consumable substance; and
the attribute associated with the search category is selected from a group of attributes consisting of: reduce fatigue, relieve headaches, relieve stress, reduce anxiety, and ease pain.

18. The method of claim 15, wherein:
the search category is a taste category associated with the consumable substance; and
the attribute associated with the search category is selected from a group of attributes consisting of: sweet, citrus, flowery, spicy, and bitter.

19. The method of claim 16, wherein the group of attributes associated with the search category includes biometric data captured by a wearable sensor of a user interacting with the graphical user interface.

20. The method of claim 15, wherein the database query is constructed based on location coordinates of a plurality of graphical representation present within a region on a touch-enabled interface screen.
